(19) United States
(12) Patent Application Publication
(10) Pub. No.: US 2026/0211862 A1
(43) Pub. Date: Jul. 23, 2026

(54) Schema-Based Generative Artificial Intelligence Responses in Telemetry Data Systems

(71) Applicant: Dell Products L.P., Round Rock, TX (US)

(72) Inventors: Michael Barnes, Doylestown, PA (US); Abinandaraj Rajendran, Cary, NC (US); Joseph Grigg, Raleigh, NC (US); Edward Henry, Jurupa Valley, CA (US); Robert Duncan Harper, Ipswich (GB)

(21) Appl. No.: 19/030,153

(22) Filed: Jan. 17, 2025

(51) Int. Cl. G06F 16/22; G06F 16/21; G06F 16/248

(52) U.S. Cl. CPC G06F 16/2237; G06F 16/211; G06F 16/248

(57) ABSTRACT

A system can receive a query from a remote computing system and to a generative artificial intelligence (genAI) system, wherein the query relates to a computing system. The system can vectorize the query. The system can determine vectorized schema description properties that satisfy a similarity criterion with respect to the vectorized query, wherein respective vectorized schema description properties of the vectorized schema description properties comprise respective identifiers of respective corresponding schema, and wherein the vectorized schema description properties relate to the computing system. The system can retrieve the respective corresponding schema based on the respective identifiers in the respective vectorized schema description properties, to produce retrieved schema. The system can create a prompt that comprises the query and a parameter description from the retrieved schema. The system can prompt the genAI system with the prompt to produce an output, and send the output to the remote computing system.

### BACKGROUND

Generative artificial intelligence (genAI) can generally comprise a type of AI system that is configured to generate and output media (e.g., text or images) based on an input.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can receive a query from a remote computing system and to a generative artificial intelligence system, wherein the query relates to a computing system. The system can vectorize the query to produce a vectorized query. The system can determine vectorized schema description properties that satisfy a similarity criterion with respect to the vectorized query, wherein respective vectorized schema description properties of the vectorized schema description properties comprise respective identifiers of respective corresponding schema, and wherein the vectorized schema description properties relate to the computing system. The system can retrieve the respective corresponding schema based on the respective identifiers in the respective vectorized schema description properties, to produce retrieved schema. The system can create a prompt that comprises the query and a parameter description from the retrieved schema. The system can prompt the generative artificial intelligence system with the prompt to produce an output. The system can send the output to the remote computing system.

An example method can comprise receiving, by a system comprising at least one processor, a query from a remote computer system, wherein the query relates to a computer system. The method can further comprise determining, by the system, vectorized schema description properties that satisfy a similarity criterion with respect to a vectorized query that corresponds to the query, wherein respective vectorized schema description properties of the vectorized schema description properties comprise respective identifiers of respective corresponding schema, and wherein the vectorized schema description properties relate to the computer system. The method can further comprise retrieving, by the system, the respective corresponding schema based on the respective identifiers in the respective vectorized schema description properties, to produce retrieved schema. The method can further comprise creating, by the system, a prompt that comprises the query and a parameter description from the retrieved schema. The method can further comprise, in response to inputting the prompt to a generative artificial intelligence system, obtaining, by the system, an output from the generative artificial intelligence system that was generated based on the prompt.

An example non-transitory computer-readable medium can comprise instructions that, in response to execution, cause a system comprising a processor to perform operations. These operations can comprise receiving a query that relates to computing equipment. These operations can further comprise determining vectorized schema description properties of the computing equipment that satisfy a similarity criterion with respect to a vectorized version of the query, wherein respective vectorized schema description properties of the vectorized schema description properties comprise respective identifiers of respective corresponding schema. These operations can further comprise retrieving the respective corresponding schema based on the respective identifiers in the respective vectorized schema description properties. These operations can further comprise creating a prompt that comprises the query and a parameter description from the schema. These operations can further comprise prompting a generative artificial intelligence system with the prompt to produce an output. These operations can further comprise receiving, from the generative artificial intelligence system, a response resulting from the prompting of the generative artificial intelligence system.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate schema-based genAI responses in telemetry data systems, in accordance with an embodiment of this disclosure;

FIG. 2 illustrates an example of processor configuration schema, and that can facilitate schema-based genAI responses in telemetry data systems, in accordance with an embodiment of this disclosure;

FIG. 3 illustrates an example of processor metric schema, and that can facilitate schema-based genAI responses in telemetry data systems, in accordance with an embodiment of this disclosure;

FIG. 4 illustrates another example system architecture that can facilitate schema-based genAI responses in telemetry data systems, in accordance with an embodiment of this disclosure;

FIG. 5 illustrates an example process flow that can facilitate schema-based genAI responses in telemetry data systems, in accordance with an embodiment of this disclosure;

FIG. 6 illustrates another example system architecture that can facilitate schema-based genAI responses in telemetry data systems, in accordance with an embodiment of this disclosure;

FIG. 7 illustrates another example process flow that can facilitate schema-based genAI responses in telemetry data systems, in accordance with an embodiment of this disclosure;

FIG. 8 illustrates another example process flow that can facilitate schema-based genAI responses in telemetry data systems, in accordance with an embodiment of this disclosure;

FIG. 9 illustrates another example process flow that can facilitate schema-based genAI responses in telemetry data systems, in accordance with an embodiment of this disclosure;

FIG. 10 illustrates an example block diagram of a computer operable to execute an embodiment of this disclosure.

### DETAILED DESCRIPTION

### Overview

Telemetry can generally comprise an approach for collecting and analyzing data from remote sources to gain insights into performance and failure analysis. Data corresponding to telemetry in the forms of configuration, metrics and alerts, for example, can be sent by both edge and non-edge devices where the former can be sensors, wearables, and smart devices; and the latter can be data center cloud servers, mainframes and storage appliances. Where telemetry data is voluminous, it can be transmitted and stored in compacted formats. It can be that telemetry data in a compacted format is unusable by generative artificial intelligence (GenAI) systems (which can generally comprise AI systems that ae configured to generative media (e.g., text or an image) that is responsive to an input statement) that attempt to provide user experience that incorporates their device specific data. The present techniques can be implemented to address this problem by injecting information from telemetry data schema with the actual telemetry data. The present techniques can also provide a mechanism to search the schema to determine the appropriate data that should be included based on user queries to a generative AI system.

Schema definition and validation can be leveraged for streaming big data infrastructure. Schema can generally comprise a parameter name, data type including primitives and collections, descriptions of the property/parameter, as well as additional descriptors to meet specific system/framework requirements.

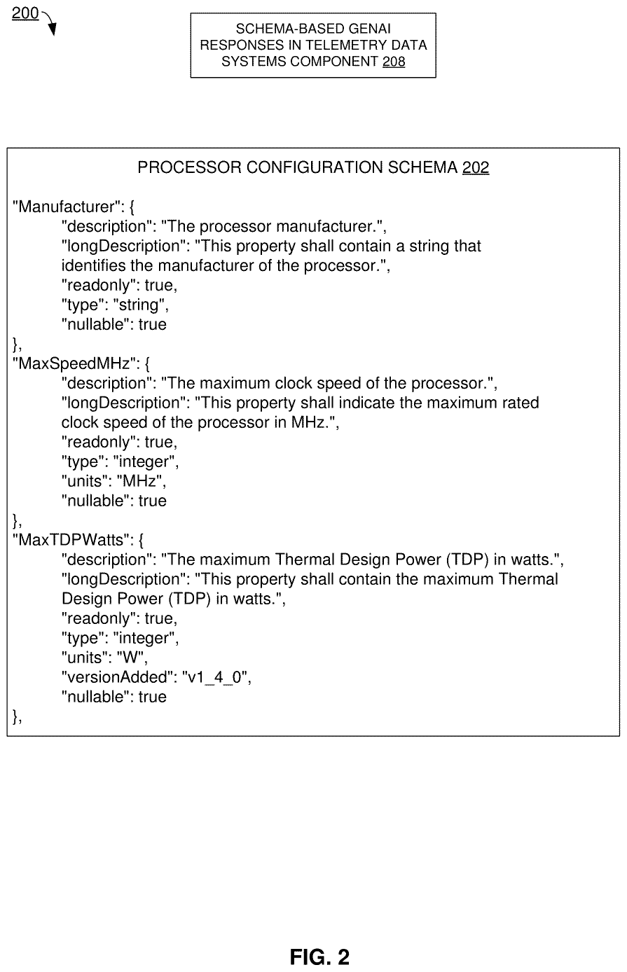

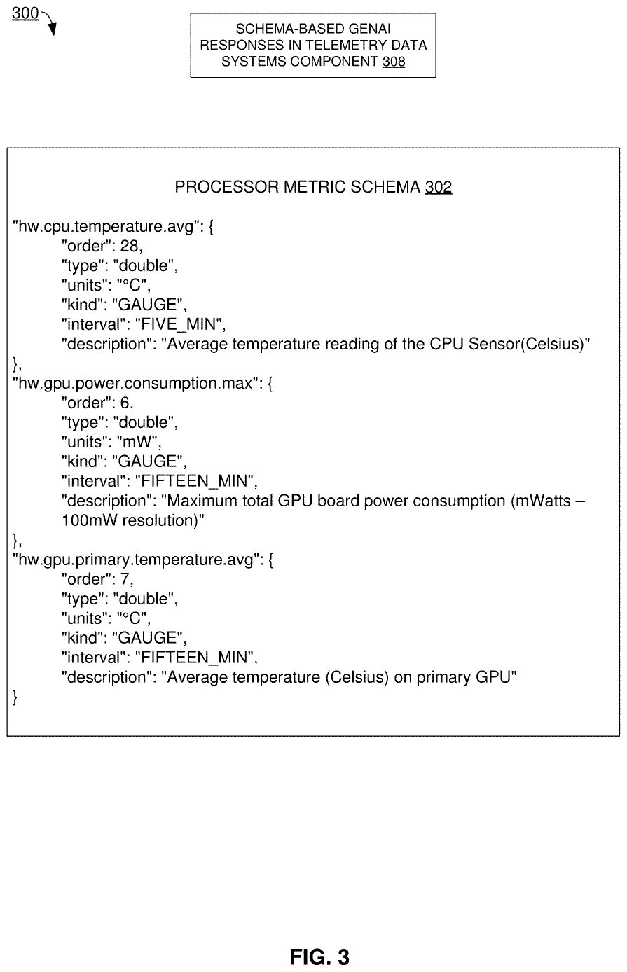

The following are examples of configuration and metric schema. Processor configuration schema examples are illustrated with respect to FIG. 2. Processor metric schema examples are illustrated with respect to FIG. 3.

In some examples, the present techniques can incorporate a retrieval augmented generation system (RAG, which can generally combine a genAI system with an information source, such as a database or knowledge base, that can input text into the genAI system), where the descriptions of schema parameters can be used to create embeddings for a vector search. When users ask questions specific to their systems, the schema description can be is used to identify parameters that align with the user query. Once the parameters are identified from the RAG, a subsequent query can be made to traditional data stores containing configuration, telemetry, metric and/or alert data.

Identifying relevant system data to include in large language model (LLM, which can generally comprise a type of a genAI system that is configured to understand, generate, and manipulate human language) prompts can be implemented as follows. A user can ask a generative AI chatbot for specifics relating to systems in the user's data centers. There can be thousands to hundreds of thousands of parameters for each system; the RAG/LLM can then determine the relevant system data for inclusion in a prompt to the LLM.

It can be that including strings (e.g., JavaScript Object Notation (JSON) strings) with key-value pairs can be insufficient to retrieve appropriate and relevant system data. It can be that the keys are often approximations and anacronyms rendering key search virtually useless.

The present techniques can facilitate schema-based RAG queries to enable personalized data inclusion for LLM prompts.

Examples of the present techniques include a retrieval augmented generation (RAG), where descriptions of schema parameters can be used to create embeddings for vector search. When users ask questions specific to their systems, the schema description RAG can be used to identify parameters that align with the user query. Once the parameters are identified from the schema-based RAG, a subsequent query can be made to a data stores containing configuration, telemetry, metric and/or alert data according to these schema properties. A schema property description can be included with the actual data in a prompt that is forwarded to a LLM for response to user query.

Other examples of the present techniques can facilitate a multilevel instruction-based prompt that combines RAG document retrieval results with RAG schema property results to facilitate a LLM response that provides specific system information and associated documentation relevant to understanding and/or remediation.

Prior approaches can generally comprise combining data from two different sources including user specific data retrieved from object stores (e.g., databases). In contrast, the present techniques can relate to getting user data highly specific to a query out of object stores (databases) with a RAG search on schema embedded in vector database followed by retrieval from a database for the highly specific schema. For example, if looking for graphics processing unit (GPU) utilization for a computer system, the inquiry can relate to schema, schema description, and values for GPU utilization; not all metric values for the computer system. This present techniques can facilitate a highly-selective retrieval of specific properties—e.g., the GPU utilization. That is, the present techniques can relate to obtaining highly specific data for a specified query or AI task.

### Example Architectures, Etc.

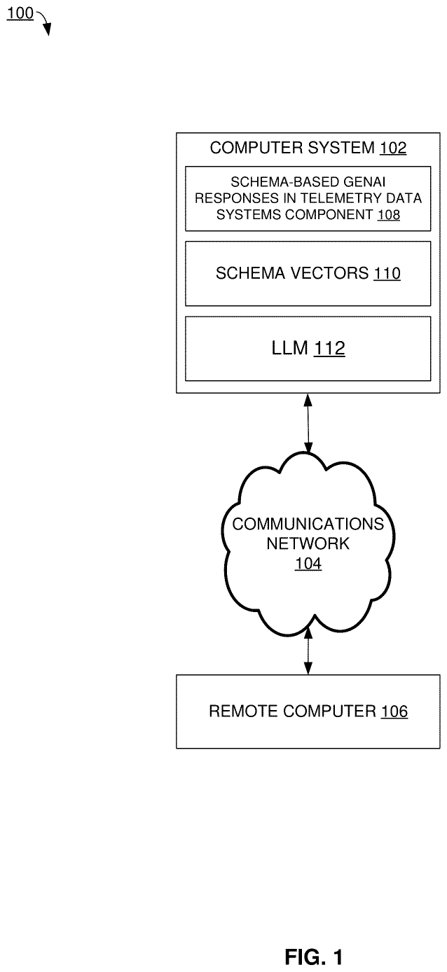

FIG. 1 illustrates an example system architecture 100 that can facilitate schema-based genAI responses in telemetry data systems, in accordance with an embodiment of this disclosure.

System architecture 100 comprises computer system 102, communications network 104, and remote computer 106. Computer system 102 comprises schema-based genAI responses in telemetry data systems component 108, schema vectors 110, and large language model (LLM) 112.

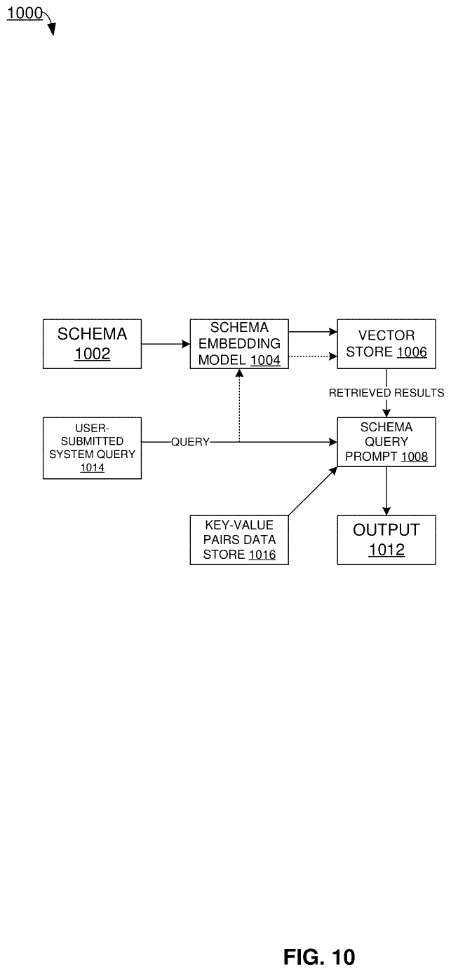

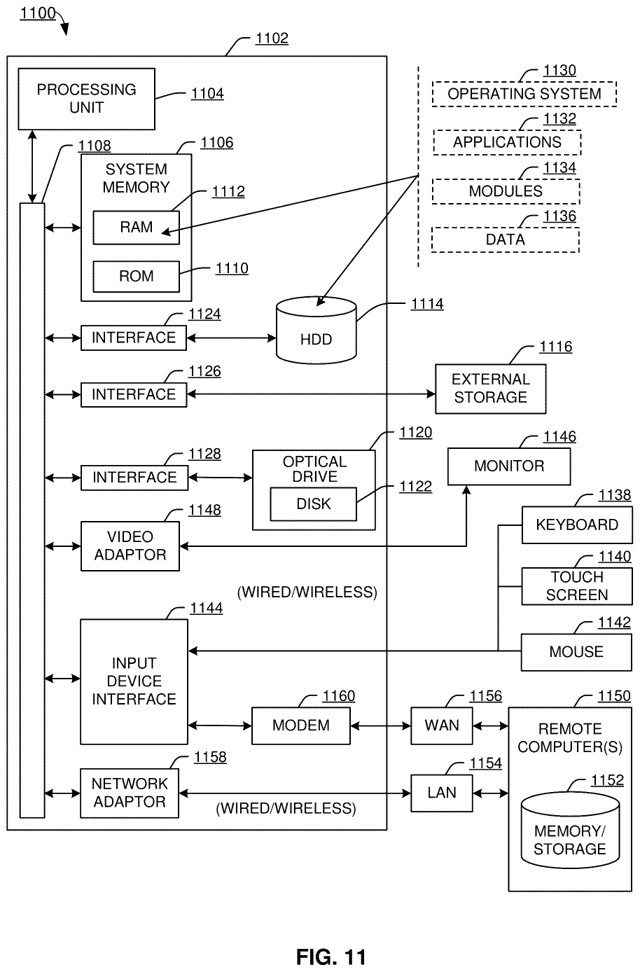

Each of computer system 102 and/or remote computer 106 can be implemented with part(s) of computing environment 1000 of FIG. 10. Communications network 104 can comprise a computer communications network, such as the Internet.

Remote computer 106 can provide a query to computer system 102 via communications network 104. Based on the query, schema-based genAI responses in telemetry data systems component 108 can determine relevant schema information for the query from schema vectors 110. Schema-based genAI responses in telemetry data systems component 108 can input this relevant schema information and the query into LLM 112 to determine an answer to the query, and provide that answer to remote computer 106 via communications network 104.

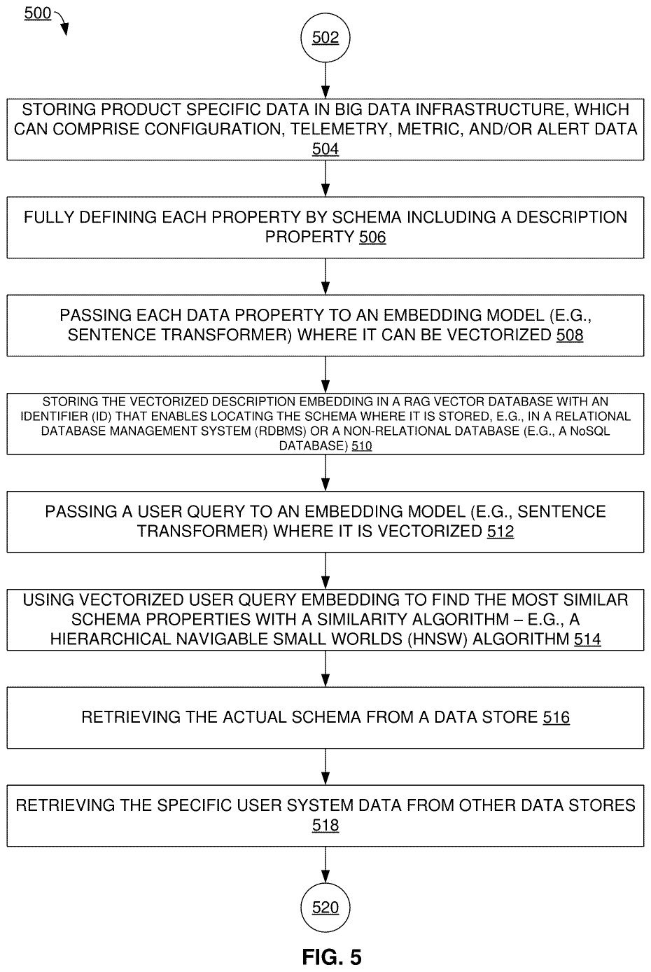

In some examples, schema-based genAI responses in telemetry data systems component 108 can implement part(s) of the process flows of FIGS. 5 and/or 7-9 to implement schema-based genAI responses in telemetry data systems.

It can be appreciated that system architecture 100 is one example system architecture for schema-based genAI responses in telemetry data systems, and that there can be other system architectures that facilitate schema-based genAI responses in telemetry data systems.

FIG. 2 illustrates an example 200 of processor configuration schema, and that can facilitate schema-based genAI responses in telemetry data systems, in accordance with an embodiment of this disclosure. In some examples, part(s) of example 200 can be implemented by part(s) of system architecture 100 of FIG. 1 to facilitate schema-based genAI responses in telemetry data systems.

Example 200 comprises processor configuration schema 202 and schema-based genAI responses in telemetry data systems component 208 (which can be similar to schema-based genAI responses in telemetry data systems component 108 of FIG. 1). Processor configuration schema 202 is:

```
″Manufacturer″: {
  ″description″: ″The processor manufacturer.″,
  ″longDescription″: ″This property shall contain a string that
identifies the manufacturer of the processor.″,
  ″readonly″: true,
  ″type″: ″string″,
  ″nullable″: true
},
″MaxSpeedMHz″: {
  ″description″: ″The maximum clock speed of the processor.″,
  ″longDescription″: ″This property shall indicate the maximum rated
clock speed of the processor in MHz.″,
  ″readonly″: true,
  ″type″: ″integer″,
  ″units″: ″MHz″,
  ″nullable″: true
},
″MaxTDPWatts″: {
  ″description″: ″The maximum Thermal Design Power (TDP) in
  watts.″,
  ″longDescription″: ″This property shall contain the maximum
Thermal Design Power (TDP) in watts.″,
  ″readonly″: true,
  ″type″: ″integer″,
  ″units″: ″W″,
  ″versionAdded″: ″v1_4_0″,
  ″nullable″: true
},
```

FIG. 3 illustrates an example 300 of processor metric schema, and that can facilitate schema-based genAI responses in telemetry data systems, in accordance with an embodiment of this disclosure. In some examples, part(s) of example 300 can be implemented by part(s) of system architecture 100 of FIG. 1 to facilitate schema-based genAI responses in telemetry data systems.

Example 300 comprises processor metric schema 302 and schema-based genAI responses in telemetry data systems component 308 (which can be similar to schema-based genAI responses in telemetry data systems component 108 of FIG. 1). Processor metric schema 302 is:

```
″hw.cpu.temperature.avg″: {
  ″order″: 28,
  ″type″: ″double″,
  ″units″: ″° C.″,
  ″kind″: ″GAUGE″,
  ″interval″: ″FIVE_MIN″,
  ″description″: ″Average temperature reading of the CPU
  Sensor(Celsius)″
},
″hw.gpu.power.consumption.max″: {
  ″order″: 6,
  ″type″: ″double″,
  ″units″: ″mW″,
  ″kind″: ″GAUGE″,
  ″interval″: ″FIFTEEN_MIN″,
  ″description″: ″Maximum total GPU board power consumption
(mWatts - 100mW resolution)″
},
″hw.gpu.primary.temperature.avg″: {
  ″order″: 7,
  ″type″: ″double″,
  ″units″: ″º C.″,
  ″kind″: ″GAUGE″,
  ″interval″: ″FIFTEEN_MIN″,
  ″description″: ″Average temperature (Celsius) on primary GPU″
}
```

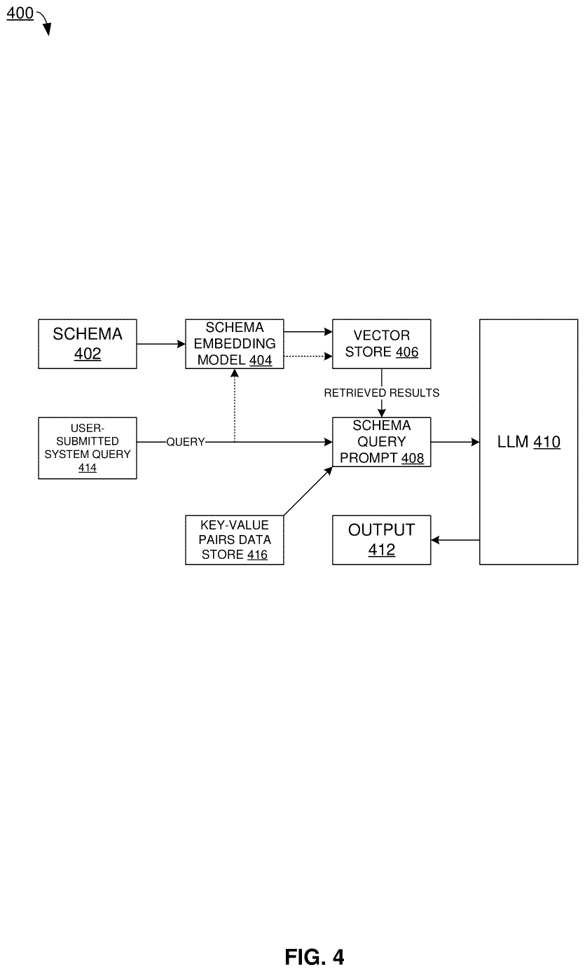

FIG. 4 illustrates another example system architecture 400 that can facilitate schema-based genAI responses in telemetry data systems, in accordance with an embodiment of this disclosure. In some examples, part(s) of system architecture 400 can be implemented by part(s) of system architecture 100 of FIG. 1 to facilitate schema-based genAI responses in telemetry data systems.

System architecture 400 comprises schema 402, schema embedding model 404, vector store 406, schema query prompt 408, LLM 410, output 412, and user-submitted system query 414.

An example of the present techniques can incorporate an approach to facilitate the inclusion of system configuration, telemetry, metric, and alert data relating to user queries. This can define a personalization mechanism for providing user-specific data/answers relating to their systems and system performance. In some examples, process flow 500 of FIG. 5 can be applied to system architecture 400 of FIG. 4.

FIG. 5 illustrates an example process flow 500 that can facilitate schema-based genAI responses in telemetry data systems, in accordance with an embodiment of this disclosure. In some examples, one or more embodiments of process flow 500 can be implemented by schema-based genAI responses in telemetry data systems component 108 of FIG. 1, or computing environment 1000 of FIG. 10.

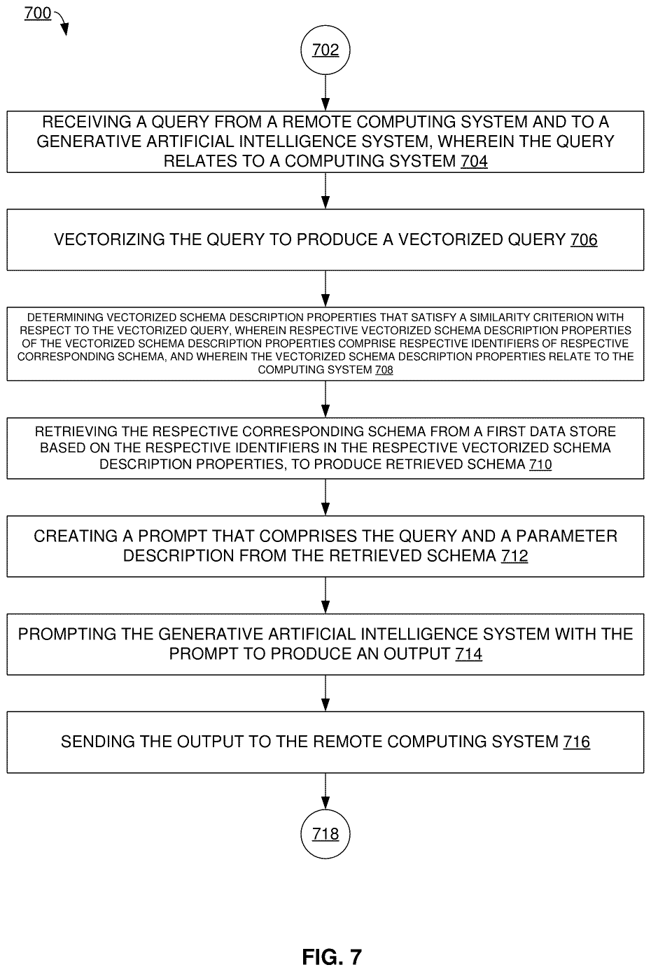

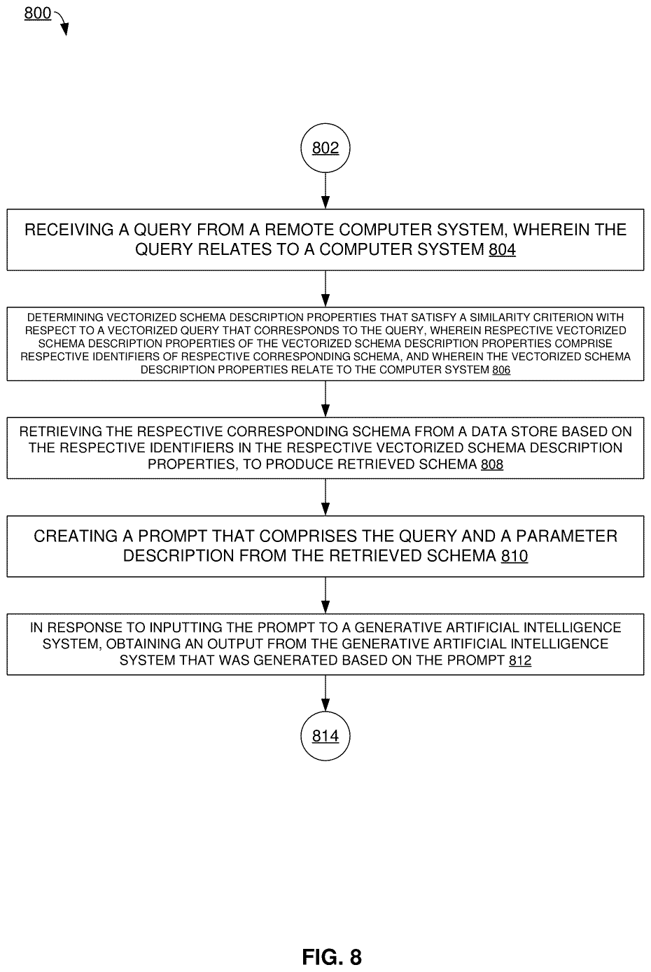

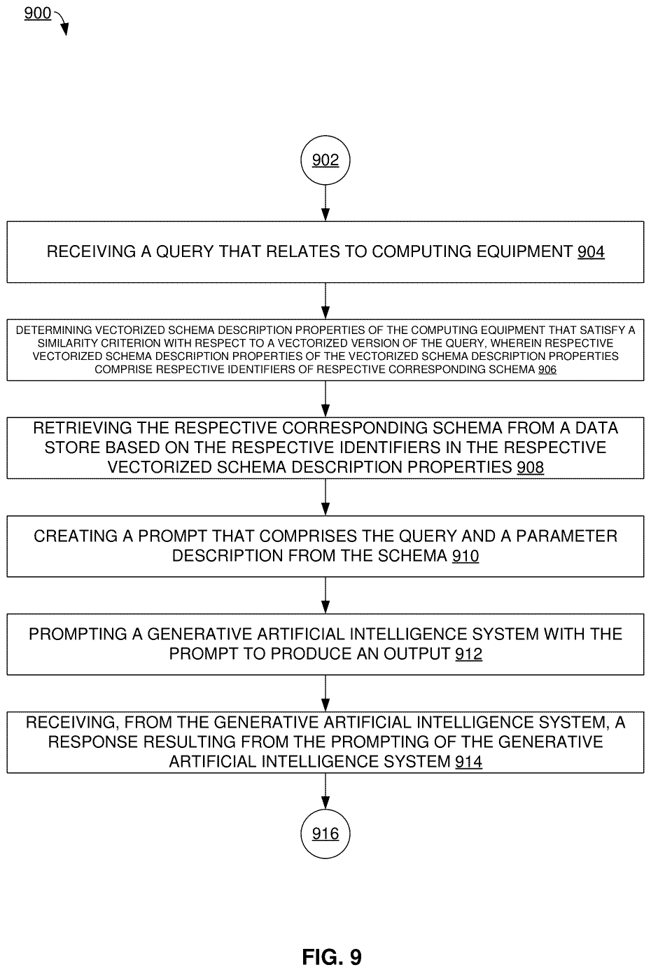

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 700 of FIG. 7, process flow 800 of FIG. 8, and/or process flow 900 of FIG. 9.

Process flow 500 begins with 502, and moves to operation 504.

Operation 504 depicts storing product specific data in big data infrastructure, which can comprise configuration, telemetry, metric, and/or alert data.

After operation 504, process flow 500 moves to operation 506.

Operation 506 depicts fully defining each property by schema including a description property.

After operation 506, process flow 500 moves to operation 508.

Operation 508 depicts passing each data property to an embedding model (e.g., sentence transformer) where it can be vectorized.

After operation 508, process flow 500 moves to operation 510.

Operation 510 depicts storing the vectorized description embedding in a RAG vector database with an identifier (ID) that enables locating the schema where it is stored, e.g., in a relational database management system (RDBMS) or a non-relational database (e.g., a NoSQL database).

After operation 510, process flow 500 moves to operation 512.

Operation 512 depicts passing a user query to an embedding model (e.g., sentence transformer) where it is vectorized.

After operation 512, process flow 500 moves to operation 514.

Operation 514 depicts using vectorized user query embedding to find the most similar schema properties with a similarity algorithm—e.g., a hierarchical navigable small worlds (HNSW) algorithm.

After operation 514, process flow 500 moves to operation 516.

Operation 516 depicts retrieving the actual schema from a data store.

After operation 516, process flow 500 moves to operation 518.

Operation 518 depicts retrieving the specific user system data from other data stores.

After operation 518, process flow 500 moves to 520, where process flow 500 ends.

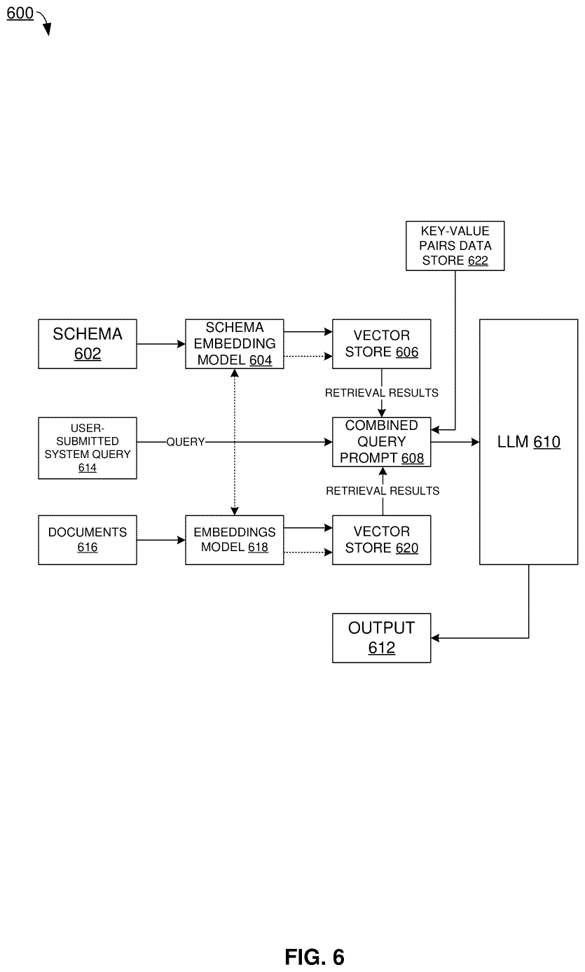

FIG. 6 illustrates another example system architecture 600 that can facilitate schema-based genAI responses in telemetry data systems, in accordance with an embodiment of this disclosure. In some examples, part(s) of system architecture 600 can be implemented by part(s) of system architecture 100 of FIG. 1 to facilitate schema-based genAI responses in telemetry data systems.

System architecture 600 comprises schema 602, schema embedding model 604, vector store 606, combined query prompt 608, LLM 610, output 612, user-submitted system query 614, documents 616, embeddings model 618, and vector store 620.

Another example of the present techniques can combine the example of FIG. 4 with a parallel RAG that takes a user query to provide relevant documents (e.g., knowledge base articles, manuals, guide, whitepapers). The text from these documents can be combined with the data prompt from FIG. 4 to create a new prompt comprising both user specific data and relevant documentation. The LLM can then provide an answer to the user query based on both system specific data and relevant documentation.

### Example Process Flows

FIG. 7 illustrates another example process flow 700 that can facilitate schema-based genAI responses in telemetry data systems, in accordance with an embodiment of this disclosure. In some examples, one or more embodiments of process flow 700 can be implemented by schema-based genAI responses in telemetry data systems component 108 of FIG. 1, or computing environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 500 of FIG. 5, process flow 800 of FIG. 8, and/or process flow 900 of FIG. 9.

Process flow 700 begins with 702, and moves to operation 704.

Operation 704 depicts receiving a query from a remote computing system and to a generative artificial intelligence system, wherein the query relates to a computing system. Using the example of FIG. 1, this can comprise computer system 102 receiving a query from remote computer 106, where the query relates to some other computer system.

After operation 704, process flow 700 moves to operation 706.

Operation 706 depicts vectorizing the query to produce a vectorized query. That is, where the query is natural language text, a vector of it can be produced. This can be a fixed-length vector, that can be referred to as an embedding. The vector can capture the semantic meaning of the query in a high-dimensional space, where semantically similar queries are represented by vectors that are located near each other in this space.

After operation 706, process flow 700 moves to operation 708.

Operation 708 depicts determining vectorized schema description properties that satisfy a similarity criterion with respect to the vectorized query, wherein respective vectorized schema description properties of the vectorized schema description properties comprise respective identifiers of respective corresponding schema, and wherein the vectorized schema description properties relate to the computing system. That is, there can be schema that relate to the computing system for which the query is issued, and schema that relate to the query can be identified by comparing their vectorized schema description properties to the vectorized query.

After operation 708, process flow 700 moves to operation 710.

Operation 710 depicts retrieving the respective corresponding schema based on the respective identifiers in the respective vectorized schema description properties, to produce retrieved schema. That is, based on identifying relevant vectors, the actual schema that correspond to those vectors can be accessed.

In some examples, the retrieved schema comprise respective formats for describing respective components of the computing system. In some examples, respective retrieved schema of the retrieved schema comprise at least one respective schema description property, and the at least one respective schema property comprises at least one respective key-value pair. In some examples, the parameter description comprises a description of a key-value pair of a schema of the retrieved schema. This can be similar to as depicted in FIGS. 2-3.

After operation 710, process flow 700 moves to operation 712.

Operation 712 depicts creating a prompt that comprises the query and a parameter description from the retrieved schema. That is, a prompt for a genAI system can comprise both the original query as well as the schema that were accessed in operations 708-710.

In some examples, operation 712 comprises retrieving documents from a data store based on the query, where the prompt is created based on the documents. In some examples, the documents comprise a knowledge base article, a manual, a guide, or a whitepaper. In some examples, the vectorized schema description properties are stored in a first retrieval augmented generation system, and wherein the documents are stored in a second retrieval augmented generation system. In some examples, the documents comprise documentation regarding the computing system.

That is, there can be examples that utilize multiple RAGs, where a second RAG takes a user query to provide relevant documents (e.g., knowledge base articles, manuals, guide, whitepapers). The text from these documents can be combined with the data prompt from operation 712 to create a new prompt comprising both user specific data and relevant documentation. The LLM (or other genAI system) can then provide an answer to the user query based on both system specific data and relevant documentation.

After operation 712, process flow 700 moves to operation 714.

Operation 714 depicts prompting the generative artificial intelligence system with the prompt to produce an output. That is, the genAI system can be prompted with the prompt created in operation 712.

After operation 714, process flow 700 moves to operation 716.

Operation 716 depicts sending the output to the remote computing system. That is, the response to the query can be produced in operation 714, and sent—continuing with the example of FIG. 1—to remote computer 106.

After operation 716, process flow 700 moves to 718, where process flow 700 ends.

FIG. 8 illustrates another example process flow 800 that can facilitate schema-based genAI responses in telemetry data systems, in accordance with an embodiment of this disclosure. In some examples, one or more embodiments of process flow 800 can be implemented by schema-based genAI responses in telemetry data systems component 108 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 500 of FIG. 5, process flow 700 of FIG. 7, and/or process flow 900 of FIG. 9.

Process flow 800 begins with 802, and moves to operation 804.

Operation 804 depicts receiving a query from a remote computer system, wherein the query relates to a computer system. In some examples, operation 804 can be implemented in a similar manner as operation 704 of FIG. 7.

After operation 804, process flow 800 moves to operation 806.

Operation 806 depicts determining vectorized schema description properties that satisfy a similarity criterion with respect to a vectorized query that corresponds to the query, wherein respective vectorized schema description properties of the vectorized schema description properties comprise respective identifiers of respective corresponding schema, and wherein the vectorized schema description properties relate to the computer system. In some examples, operation 806 can be implemented in a similar manner as operations 706-708 of FIG. 7.

In some examples, the vectorized schema description properties identify configuration data of the computer system, telemetry data of the computer system, metrics of the computer system, or alert data of the computer system.

In some examples, operation 806 comprises creating the respective vectorized schema description properties based on respective results of processing corresponding respective descriptions with an embedding model. In some examples, the embedding model comprises a sentence transformer model. An embedding model can generally comprise a neural network that converts data into a fixed-length vector (sometimes referred to as an embedding). A sentence transformer can generally comprise a neural network that converts human-readable text (e.g., a sentence) into a fixed-length vector representation of that human-readable text.

In some examples, the vectorizing of the query to produce the vectorized query comprises processing the query with a sentence transformer model. That is, the query can be vectorized similar to how the schema description properties can be vectorized.

After operation 806, process flow 800 moves to operation 808.

Operation 808 depicts retrieving the respective corresponding schema based on the respective identifiers in the respective vectorized schema description properties, to produce retrieved schema. In some examples, operation 808 can be implemented in a similar manner as operation 710 of FIG. 7.

In some examples, the vectorized schema description properties are stored in a retrieval augmented generation vector database, and the retrieved schema are retrieved from a relational database. This can be implemented in a similar manner as operation 510 of FIG. 5. After operation 808, process flow 800 moves to operation 810.

Operation 810 depicts creating a prompt that comprises the query and a parameter description from the retrieved schema. In some examples, operation 810 can be implemented in a similar manner as operation 712 of FIG. 7.

After operation 810, process flow 800 moves to operation 812.

Operation 812 depicts in response to inputting the prompt to a generative artificial intelligence system, obtaining an output from the generative artificial intelligence system that was generated based on the prompt. In some examples, operation 812 can be implemented in a similar manner as operations 714-716 of FIG. 7.

After operation 812, process flow 800 moves to 814, where process flow 800 ends.

FIG. 9 illustrates another example process flow 900 that can facilitate schema-based genAI responses in telemetry data systems, in accordance with an embodiment of this disclosure. In some examples, one or more embodiments of process flow 900 can be implemented by schema-based genAI responses in telemetry data systems component 108 of FIG. 1, or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 500 of FIG. 5, process flow 700 of FIG. 7, and/or process flow 800 of FIG. 8.

Process flow 900 begins with 902, and moves to operation 904.

Operation 904 depicts receiving a query that relates to computing equipment. In some examples, operation 904 can be implemented in a similar manner as operation 704 of FIG. 7.

After operation 904, process flow 900 moves to operation 906.

Operation 906 depicts determining vectorized schema description properties of the computing equipment that satisfy a similarity criterion with respect to a vectorized version of the query, wherein respective vectorized schema description properties of the vectorized schema description properties comprise respective identifiers of respective corresponding schema. In some examples, operation 906 can be implemented in a similar manner as operations 706-708 of FIG. 7.

In some examples, the determining of the vectorized schema description properties that satisfy the similarity criterion with the vectorized version of the query is performed based on a similarity search. In some examples, the determining of the vectorized schema description properties that satisfy the similarity criterion with the vectorized version of the query is performed based on a hierarchical navigable small worlds technique.

A similarity search can generally comprise representing multiple things (e.g., schema properties) as vectors in an N-dimensional space, and then finding those vectors that are closest in that N-dimensional space to the vector for which similar vectors are being sought. A hierarchical navigable small worlds technique generally comprises creating a hierarchical graph that comprises multiple levels, with each level having different levels of connectivity and data density (with the lowest level identifying all data points, and the higher levels identifying fewer data points while having more long-rage connections). This hierarchical graph can be navigated from higher levels to lower levels to reduce the data space being searched to find similar vectors.

After operation 906, process flow 900 moves to operation 908.

Operation 908 depicts retrieving the respective corresponding schema based on the respective identifiers in the respective vectorized schema description properties. In some examples, operation 908 can be implemented in a similar manner as operation 710 of FIG. 7.

After operation 908, process flow 900 moves to operation 910.

Operation 910 depicts creating a prompt that comprises the query and a parameter description from the schema. In some examples, operation 910 can be implemented in a similar manner as operation 712 of FIG. 7.

In some examples, the performing of the creating of the prompt is based on system data that corresponds to an operating state of the computing equipment. In some examples, the operations further comprise identifying the system data based on the schema. This system data can comprise information about the computer system for which the query is issued (e.g., a processor or memory load of that specific computer system). A parameter description from the schema can be used to identify which system data is relevant to the query. Using system-specific data in this manner can lead to providing a system-specific answer to the query.

After operation 910, process flow 900 moves to operation 912.

Operation 912 depicts prompting a generative artificial intelligence system with the prompt to produce an output. In some examples, operation 912 can be implemented in a similar manner as operation 714 of FIG. 7.

In some examples, the generative artificial intelligence system comprises a large language model.

After operation 912, process flow 900 moves to operation 914.

Operation 914 depicts receiving, from the generative artificial intelligence system, a response resulting from the prompting of the generative artificial intelligence system. In some examples, operation 914 can be implemented in a similar manner as operation 716 of FIG. 7.

After operation 914, process flow 900 moves to 916, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of computer system 102, and/or remote computer 106.

In some examples, computing environment 1000 can implement one or more embodiments of the process flows of FIGS. 5 and/or 7-9 to facilitate schema-based genAI responses in telemetry data systems.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples, and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
at least one processor; and
at least one memory that stores executable instructions that, when executed by the at least one processor, facilitate performance of operations, comprising:
storing respective telemetry data for a computing system in a data store, wherein the respective telemetry data corresponds to respective types;
storing respective schema that are based on the respective types of the respective telemetry data, and wherein the respective schema comprise respective description properties that describe the respective types in a natural language format;
vectorizing the respective description properties to produce respective vectorized schema description properties;
storing the respective vectorized schema description properties vectors in a vector store;
receiving a query from a remote computing system and to a generative artificial intelligence system, wherein the query identifies an inquiry about the computing system;
vectorizing the query to produce a vectorized query;
determining a subset of the respective vectorized schema description properties that satisfy a similarity criterion with respect to the vectorized query;
retrieving a subset of the respective schema that correspond to the subset of the respective vectorized schema description properties, to produce retrieved schema;
creating a prompt that comprises the query and a parameter description that is identified in the retrieved schema;
prompting the generative artificial intelligence system with the prompt to produce an output that is based on a value of the telemetry data that corresponds to the parameter description; and
sending the output to the remote computing system.

2. The system of claim 1, wherein the operations further comprise:
retrieving documents from a data store based on the query, and wherein the prompt is created based on the documents.

3. The system of claim 2, wherein the documents comprise a knowledge base article, a manual, a guide, or a whitepaper.

4. The system of claim 3, wherein the vectorized schema description properties are stored in a first retrieval augmented generation system, and wherein the documents are stored in a second retrieval augmented generation system.

5. The system of claim 3, wherein the documents comprise documentation regarding the computing system.

6. The system of claim 1, wherein the retrieved schema comprise respective formats for describing respective components of the computing system.

7. The system of claim 1, wherein respective retrieved schema of the retrieved schema comprise at least one respective schema description property, and wherein the at least one respective schema property comprises at least one respective key-value pair.

8. The system of claim 1, wherein the parameter description comprises a description of a key-value pair of a schema of the retrieved schema.

9. A method, comprising:
storing, by a system comprising at least one processor, respective telemetry data for a computing system in a data store, wherein the respective telemetry data corresponds to respective types;
storing, by the system, respective schema that are based on the respective types of the respective telemetry data, and wherein the respective schema comprise respective description properties that describe the respective types in a natural language format;
vectorizing, by the system, the respective description properties to produce respective vectorized schema description properties;
storing, by the system, the respective vectorized schema description properties vectors in a vector store;
receiving, by the system, a query from a remote computer system, wherein the query relates to the computer system;
determining, by the system, a subset of the respective vectorized schema description properties that satisfy a similarity criterion with respect to a vectorized query that corresponds to the query;
retrieving, by the system, a subset of the respective schema that correspond to the subset of the respective vectorized schema description properties, to produce retrieved schema;
creating, by the system, a prompt that comprises the query and a parameter description that is identified in the retrieved schema; and
in response to inputting the prompt to a generative artificial intelligence system, obtaining, by the system, an output from the generative artificial intelligence system that was generated based on the prompt, wherein the output is based on a value of the telemetry data that corresponds to the parameter description.

10. The method of claim 9, wherein the vectorized schema description properties identify configuration data of the computer system, telemetry data of the computer system, metrics of the computer system, or alert data of the computer system.

11. The method of claim 9, further comprising:
creating, by the system, the respective vectorized schema description properties based on respective results of processing corresponding respective descriptions with an embedding model.

12. The method of claim 11, wherein the embedding model comprises a sentence transformer model.

13. The method of claim 9, wherein the vectorized schema description properties are stored in a retrieval augmented generation vector database, and wherein the retrieved schema are retrieved from a relational database.

14. The method of claim 9, wherein the vectorizing of the query to produce the vectorized query comprises processing the query with a sentence transformer model.

15. A non-transitory computer-readable medium comprising instructions that, in response to execution, cause a system comprising at least one processor to perform operations, comprising:
storing respective telemetry data for computing equipment in a data store, wherein the respective telemetry data corresponds to respective types;
storing respective schema that are based on the respective types of the respective telemetry data, and wherein the respective schema comprise respective description properties that describe the respective types in a natural language format;
vectorizing the respective description properties to produce respective vectorized schema description properties;
storing the respective vectorized schema description properties vectors in a vector store;
receiving a query that relates to the computing equipment;
determining a subset of the respective vectorized schema description properties of the computing equipment that satisfy a similarity criterion with respect to a vectorized version of the query;
retrieving a subset of the respective schema that correspond to the subset of the respective vectorized schema description properties;
creating a prompt that comprises the query and a parameter description from the subset of the respective schema;
prompting a generative artificial intelligence system with the prompt; and
receiving, from the generative artificial intelligence system, a response resulting from the prompting of the generative artificial intelligence system, wherein the response is based on a value of the telemetry data that corresponds to the parameter description.

16. The non-transitory computer-readable medium of claim 15, wherein the determining of the vectorized schema description properties that satisfy the similarity criterion with the vectorized version of the query is performed based on a similarity search.

17. The non-transitory computer-readable medium of claim 15, wherein the determining of the vectorized schema description properties that satisfy the similarity criterion with the vectorized version of the query is performed based on a hierarchical navigable small worlds technique.

18. The non-transitory computer-readable medium of claim 15, wherein the performing of the creating of the prompt is based on system data that corresponds to an operating state of the computing equipment.

19. The non-transitory computer-readable medium of claim 18, wherein the operations further comprise identifying the system data based on the schema.

20. The non-transitory computer-readable medium of claim 15, wherein the generative artificial intelligence system comprises a large language model.
